(19) United States
(12) Patent Application Publication
(10) Pub. No.: US 2014/0188499 A1
(43) Pub. Date: Jul. 3, 2014

(54) HUMAN ACTION MONITOR

(71) Applicants: Kevin Bell, Pittsburgh, PA (US); Bernard P. Bechara, Pittsburgh, PA (US); Robert A. Hartman, Brigeville, PA (US)

(72) Inventors: Kevin Bell, Pittsburgh, PA (US); Bernard P. Bechara, Pittsburgh, PA (US); Robert A. Hartman, Brigeville, PA (US)

(21) Appl. No.: 13/995,072

(22) PCT Filed: Jan. 12, 2012
(86) PCT No.: PCT/US12/21090

§ 371 Date: Sep. 13, 2013

Related U.S. Application Data
(60) Provisional application No. 61/432,434, filed on Jan. 13, 2011.

(51) Int. Cl. G06F 19/00; A63B 71/06

(52) U.S. Cl. CPC G06F 19/3418; A63B 71/06
USPC 705/2

(57) ABSTRACT

Systems and corresponding methodologies that enable continuous, real-time or near real-time monitoring of joint activity of patients who are undergoing physical therapy is provided. A joint's motion patterns can be measured using a six degree of freedom combine accelerometer, magnometer and gyroscope sensors that are placed above and below (or in proximity of) the joint. The data is stored on a data logger that is carried by a patient, e.g., clipped to the patient's belt and can be uploaded onto a website when attached to a computer, e.g., via a USB cord. While portable sensors are available in the market for research or gaming purposes, one key feature of the device is to provide continuous monitoring of the injured joint and electronically relay this information to the therapist, for example, via the designated website. Thus, the therapist is always informed about the patient's joint and could recommend alterations to their treatment plan.

### CROSS-REFERENCE TO RELATED APPLICATIONS

This application claims the benefit of U.S. Provisional Patent application Ser. No. 61/432,434 entitled “DAILY WEB-BASED INTERACTION: REHABILITATION THROUGH A WEARABLE MOTION TRACKING DEVICE” and filed Jan. 13, 2011. The entirety of the above-noted application is incorporated by reference herein.

### BACKGROUND

Injuries to major joints such as knees, shoulders, elbows or neck often require either surgical or conservative treatments. After surgical interventions or during conservative treatments, patients are most often referred to a physical therapist to conduct therapy sessions to restore the joint's normal range of motion (ROM).

These therapy sessions are most often conducted a few times a week for several weeks during which the therapist performs a series of manipulations and motion-based exercises to restore the joint's motion and normal levels of joint activity. This intervention is typically performed for one hour during each session and the patient is sent home with a series of recommended home-based exercises to strengthen the muscles around the joint and continue the therapy while outside the clinic. Unfortunately, because much of the therapy is performed outside of the therapist or caregiver presence, it is difficult to manage and track.

### SUMMARY

The following presents a simplified summary of the innovation in order to provide a basic understanding of some aspects of the innovation. This summary is not an extensive overview of the innovation. It is not intended to identify key/critical elements of the innovation or to delineate the scope of the innovation. Its sole purpose is to present some concepts of the innovation in a simplified form as a prelude to the more detailed description that is presented later.

The innovation disclosed and claimed herein, in one aspect thereof, comprises a system (and corresponding methodologies) for network-based (e.g., Web-based) rehabilitation via a wearable motion tracking device or set of devices. For example, the innovation can be employed in rehabilitation, strengthening, or other care (e.g., knee, hip, shoulder, spine, post-operative or injury rehabilitation). During the period of physical therapy, the therapist usually only interacts a few hours a week with the patient. Otherwise, the patient is left with minimal guidance and (little or) no feedback about his/her performance outside the clinic. The patient has to perform activities of daily living in addition to the recommended exercises, without receiving any feedback from the therapist about their performance or condition. The innovation described herein can monitor and/or record this activity for real-time (or near real-time or subsequent) analysis.

Moreover, after the patient leaves the physical therapy clinic, the therapist most often does not have any knowledge about the patient's daily condition or if he/she is complying with the recommended exercises. Traditionally, they cannot assess if the patient is performing the motion(s) correctly and not causing more damage to the body (e.g., joint). Therefore, during the time gap between the clinical visits, neither the patient, nor the therapist has any information regarding the condition and the progress of the joint's recovery.

The innovation, in one aspect thereof, provides a portable device(s) that the patient wears (e.g., across the injured joint) daily throughout the course of the physical therapy and daily activity inside and outside the clinic. This device can continuously measure (e.g., monitor and record) the joint's activity and the data can be uploaded onto a website (or other network, storage, etc.) that can be viewed by both the patient and the therapist. In addition to the joint's activity, the website can include instructions, placed by the therapist, on how to conduct the exercises and can send alerts via emails or text messages to the patient reminding of the exercise regimen, progress, etc.

In aspects, a therapist can monitor the activity of their patient's joint and recommend modifications to the therapy exercise regimen in real-time, near real-time or at a later time as desired. The combination of the wearable device and the website, will give both patient and therapist the opportunity to continuously monitor the activity of the injured joint and alter the course of therapy to improve the chances of adequate range of motion joint recovery.

To the accomplishment of the foregoing and related ends, certain illustrative aspects of the innovation are described herein in connection with the following description and the annexed drawings. These aspects are indicative, however, of but a few of the various ways in which the principles of the innovation can be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

FIG. 1 illustrates a block diagram of an example system that facilitates monitoring and tracking action in accordance with aspects of the innovation.

FIG. 2 illustrates an example sensor configuration in accordance with a cervical spine monitoring aspect of the innovation.

FIG. 3 illustrates an example interface component in accordance with aspects of the innovation.

FIG. 4 illustrates an example analysis component in accordance with aspects of the innovation.

FIG. 5 illustrates an example programming component in accordance with aspects of the innovation.

FIG. 6 illustrates an example flow chart of procedures that facilitate therapy monitoring in accordance with an aspect of the innovation.

FIG. 7 illustrates a block diagram of a computer operable to execute the disclosed architecture.

FIG. 8 illustrates a schematic block diagram of an exemplary computing environment in accordance with the subject innovation.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding of the subject innovation. It may be evident, however, that the innovation can be practiced without these specific details. In other instances, well-known structures and devices are shown in block diagram form in order to facilitate describing the innovation.

As used in this application, the terms “component” and “system” are intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

While certain ways of displaying information to users are contemplated with respect to certain embodiments, those skilled in the relevant art will recognize that various other alternatives can be employed. The terms “screen,” “web page,” and “page” are generally used interchangeably. The pages or screens are stored and/or transmitted as display descriptions, as graphical user interfaces, or by other methods of depicting information on a screen (whether personal computer, PDA, mobile telephone, or other suitable device, for example) where the layout and information or content to be displayed on the page is stored in memory, database, or another storage facility.

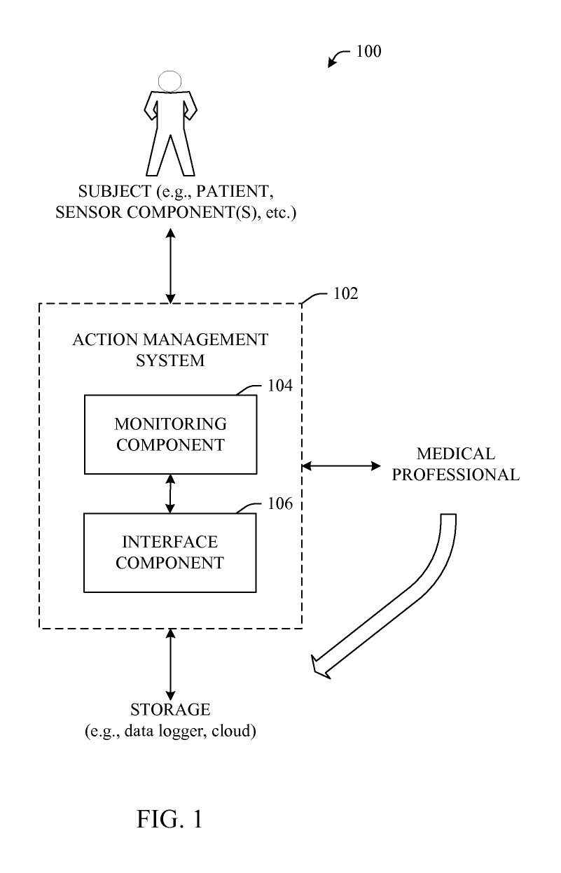

Referring initially to the drawings, FIG. 1 illustrates an example system 100 in accordance with aspects of the innovation. Generally, the system 100 can include sensor components strategically placed upon a subject or patient. The sensor components can monitor a subject's motion or action thereby conveying the information to an action management system 102. As shown, the action management system 102 can include a monitoring component 104 and an interface component 106 which can communicate with a medical professional/caregiver, patient or storage (e.g., cloud-based storage).

As described above, in one scenario, after surgery, or traumatic injury (e.g., to a joint), patients are most often referred to a physical therapist to conduct therapy sessions to restore the joint's normal range of motion (ROM). These therapy sessions are often conducted for 2-3 times a week for several weeks. During these sessions, the therapist monitors the progress of the patient's progress and ROM and performs a series of manipulations and motion-based exercises to help the patient restore their motion. This intervention is typically performed for one hour, and the patient is sent home with a series of recommended home-based exercises to strengthen the muscles around the joint and continue the therapy while outside the clinic.

During this period of physical therapy, the therapist most often only interacts few hours a week with the patient. The rest of the week, the patient is left alone with minimal guidance and little or no feedback about his/her performance and condition while outside the clinic. The patient has to perform the daily activities and the recommended exercises, but he/she does not have any feedback about their performance. In addition, after the patient leaves the physical therapy clinic, the therapist has no knowledge about how the joint is moving or if the patient is complying with the recommended exercises.

Moreover, the therapist does not have access to the patient's daily condition or if they are performing incorrect motions and causing more harm/damage to their joint or body. Therefore, during the time gap between the clinical visits, neither the patient, nor the therapist has any information regarding the condition and the progress of the patient's recovery or progress.

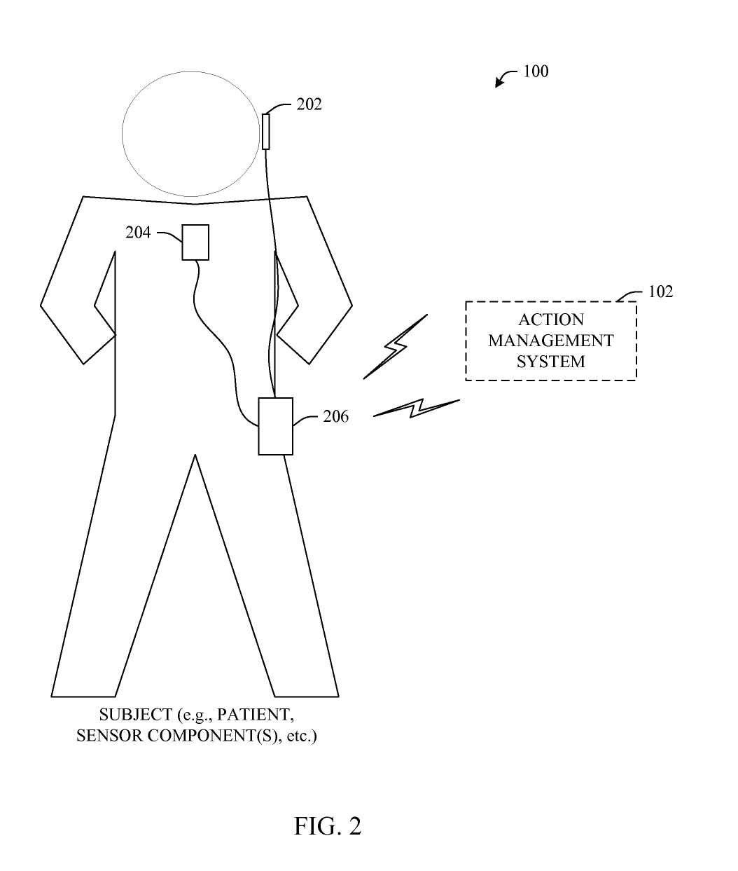

As illustrated in FIG. 1, the innovation discloses a portable device and system that the patient wears, e.g., across the injured joint, daily throughout the course of the physical therapy and other activity. As will be described herein, the sensor components can communicate (wired or wirelessly) with a data logger and/or to the action management system 102. This interaction will be better understood upon a review of FIG. 2 below.

As shown in FIG. 2, the system 100 can include sensor components (202, 204) that can continuously measure the joint's range of motion. The data can be captured via a data logger 206 and thereafter, if desired, can be uploaded onto a website that can be accessed and viewed by both the patient and the therapist. The example of FIG. 2 illustrates a configuration and orientation of sensors (202, 204) which measure ROM of a cervical spine. It is to be understood that variations of the innovation can be used to measure ROM of most any joint in the human body (or animals).

With reference again to FIG. 1, the action management component 102 can include a monitoring component 104 and an interface component 106. In operation, the monitoring component 102 can receive input from one or more sensors (e.g., 202, 204) in real-time or near real-time. The information can be stored via a data logger 206 or alternatively, directly transmitted to a storage location or cloud-based storage. In aspects, the functionality of sensor(s) and/or data logger can be co-existent in a common hardware device (e.g., cell phone, smart phone, tablet, etc.).

The interface component 104 can enable functionalities including, but not limited to, analysis, programmability, notification/alerts, etc. related to the body or a joint's activity. For example, in addition to the joint's activity, the interface component 104 can be accessed via a URL or website that can render instructions, placed (or programmed) by the therapist, on how to conduct the exercises. Additionally, the interface component 104 can facilitate transmission of alerts via emails or text messages (SMS (short message service)) to the patient to remind him/her about the exercises. It will be understood that audio and video data can be stored and rendered as appropriate and desired.

Via the interface component 104, the therapist can monitor (real-time, near real-time, recorded) the motion of the patient's joint and recommend changes to the therapy regimen. It will be understood and appreciated that the combination of the ROM device and the website, will give both patient and therapist the opportunity to continuously monitor the activity of the injured joint and alter the course of therapy to improve the chances of adequate range of motion joint recovery.

In aspects, the system 100 is a portable range of motion (ROM) device which measures (and monitors) the joint's amount of motion. The joint could be an elbow, shoulder, knee, low back, hip, or neck. The device (e.g., sensor components 202, 204) can continuously measure the motion in 6-DOF and stores the data, e.g., on a micro SD card (or other medium) in a data logger 206. As illustrated in FIG. 2, the innovation can include two (or more) sensors (202, 204) placed across the joint and a data logger (206) with power supply attached to the subject's hip (e.g., belt).

In this aspect, the sensors (202, 204) include a 3 axis accelerometer, 3 axis gyroscope, and 3 axis magnometer thus enabling measurements in 6 degrees of freedom. Also a button can be placed on the data logger 206 which can be used as a marker by the subject to indicate (or tag) instances of joint discomfort or pain. In other words, the data can be tagged at most any point in time thereby creating a record for subsequent (or simultaneous) review.

The data logger 206 can be attached to a personal computer via a USB port and the information is uploaded on a website (discussed below). While a USB connection is described, it is to be understood that most any wired or wireless technology can be employed to connect the data logger to a computer or storage medium. Among other data points, the information can include the magnitude of joint motion, the frequency of moving the joint throughout the day, and the calculated joint activity level, patient information, date/time stamps, location tags, etc.

In aspects, a website, via interface component 204 can be used by both the physical therapist and the patient. Additionally, via the interface component 204, a therapist can upload information, demonstration videos, exercise regimens, illustrations about specific exercises or movements related to the patient's therapy, messages, etc. The interface component 204 provides the therapist access to the patient's joint data to continuously monitor the patient's progress and change the therapy as needed. Also the therapist can use the pain markers (tags) that were placed by the patient to identify movement patterns that caused the discomfort. Meanwhile, the patient can also use the interface component 204 to access to the website where he/she, in addition to monitoring the progress of their joint activity, can review and learn the exercises placed by the therapist, set up alerts that are sent in the form of emails or text messages to remind the patient to conduct these exercises, etc. Further, the website can also include an activity log where the patient can enter their daily activity.

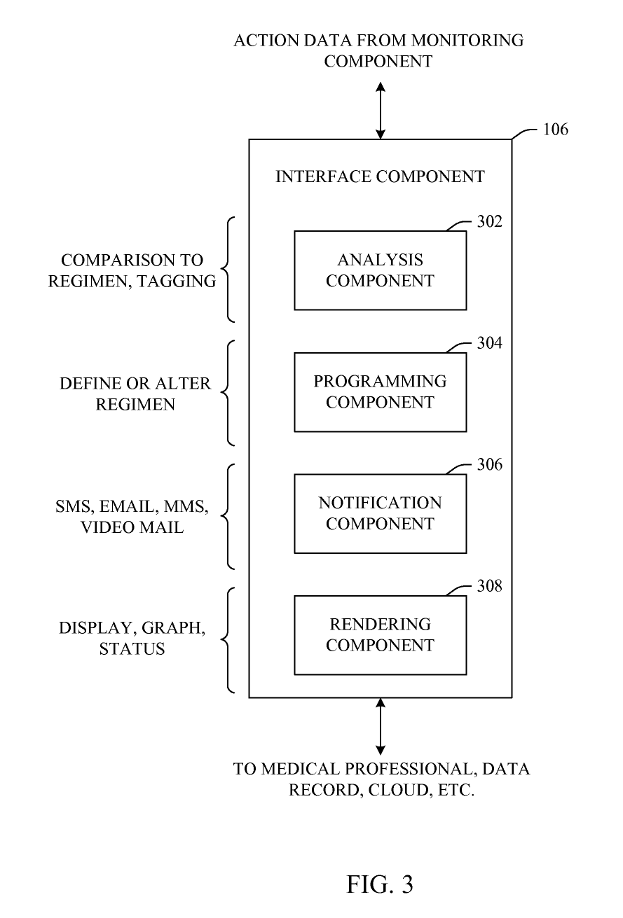

Referring now to FIG. 3, an example block diagram of an interface component 106 is shown. While certain functionalities and sub-components are described herein with regard to the systems and components of the innovation, it is to be understood that some of the sub-components and/or related functionalities can be co-located or separate from the component(s) illustrated in the block diagram. These variations are to be included within the scope of this disclosure and are not intended to depart from the spirit and scope of the innovation in any manner.

As described supra, injuries to major joints such as knees, shoulders, elbows or neck require either surgical or conservative treatments. After surgical interventions or during conservative treatments, patients are oftentimes referred to a physical therapist to conduct therapy sessions to restore the joint's normal range of motion (ROM). These therapy sessions are conducted few times a week for several weeks during which the therapist performs a series of manipulations and motion based exercises to restore the joint's motion.

This intervention is typically performed for one hour, and the patient is sent home with a series of recommended home based exercises to strengthen the muscles around the joint and continue the therapy while outside the clinic. During this period of physical therapy, the therapist only interacts few hours a week with the patient. Otherwise, the patient is left with minimal guidance and no feedback about his/her performance outside the clinic. The patient has to perform activities of daily living in addition to the recommended exercises, without receiving any feedback from the therapist about their performance or condition. Moreover, after the patient leaves the physical therapy clinic, the therapist does not have any knowledge about how the patient's daily condition or if he/she is complying with the recommended exercises. They cannot assess if the patient is performing the motions correctly and not causing more damage to the joint. Therefore, during the time gap between the clinical visits, neither the patient, nor the therapist has any information regarding the condition and the progress of the joint's recovery.

The innovation describes and discloses a portable device or system that the patient wears across the injured joint daily throughout the course of the physical therapy inside and outside the clinic as well as daily activity. This device (system 100 of FIG. 1) can continuously measure the joint's range of motion and the data can be uploaded onto, and accessed via, a website by the patient and/or the therapist, e.g., via interface component 106).

As shown in FIG. 3, the interface component 106 can generally include an analysis component 302, a programming component 304, a notification component 306 and a rendering component 308. Each of these sub-components will be described in more detail infra.

Upon receiving the data from the sensor components and/or data logger, the monitoring component can communicate with the analysis component 302 to further process the data. For example, the analysis component 302 can be used to compare the actual data to a defined or programmed exercise regimen. For instance, the data can be compared based upon range of motion, repetitions, location, time, date, etc. Moreover, the analysis component 302 can tag the data so as to enable subsequent retrieval, review, simulation, etc.

The programming component 304 enables a medical professional or caregiver to define or alter a desired or patient specific regimen. Here, a specific workout or exercise routine or regimen can be programmed in accordance with a desired rehabilitation schedule. A therapist can access the programming component 304, e.g., via the Internet, in order to alter or program a regimen in accordance with a desired plan.

The notification component 306 enables the system to send messages (e.g., SMS, email, video, MMS (multimedia message service), etc.) messages to a user and/or therapist related to a patient's regimen, progress, etc. In one embodiment, an alert can be sent to remind a patient to exercise. Similarly, an alert can be sent if a deviation of a defined regimen occurs. These alerts can be sent to either (or both) the patient and/or therapist. A therapist can receive alerts to identify when/if a regimen commences, was missed, completed, completed incorrectly, completed accurately, when data is available, etc.

The rendering component 308 enables a patient and/or therapist to access data in the form of a display (e.g., video, graph, etc.). In examples, optics included in conventional mobile devices can be used to capture video for transmission, archive and/or display. The rendering component can also enable a technician, therapist or patient to access status, progress, etc. regarding a subject's progress.

In summary, in addition to the joint's activity, the interface component 106 provides access to a website that includes instructions, placed by a therapist, on how to conduct the exercises and can send alerts via emails or text messages to the patient reminding him/her about the exercises. The therapist can monitor the motion of their patient's joint and recommend modifications to the therapy exercise regimen. The combination of the ROM system and the website, can give both patient and therapist an opportunity to continuously monitor the activity of the injured joint and alter the course of therapy to improve the chances of adequate range of motion joint recovery.

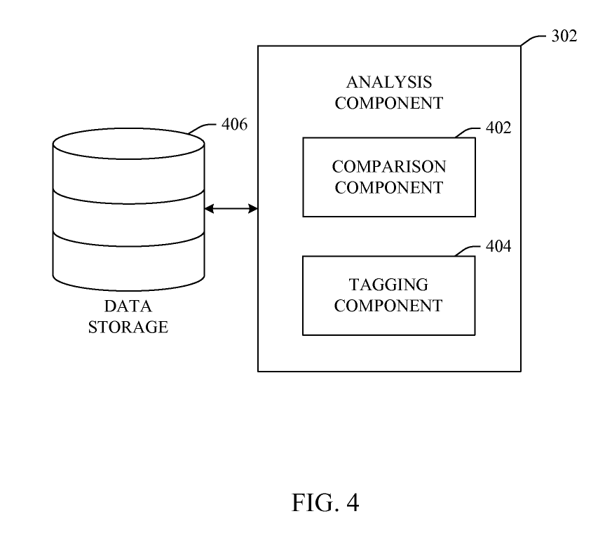

FIG. 4 illustrates an example analysis component 302 in accordance with aspects of the innovation. As described above, the analysis component 302 can enable comparison of exercise (or action) data in accordance with a designed or defined regimen. The comparison can be effectuated via a comparison component 402 that includes logic necessary complete and capture the evaluation. A tagging component 404 can be provided so as to tag the data received from the sensor components (e.g., 202, 204). For example, data can be geo-tagged as well as marked with most any data (e.g., metadata) as appropriate or desired to facilitate analysis, comparison, subsequent simulation, etc. As shown, the data can be stored into a data storage component 406 locally, distributed, cloud-based, etc.

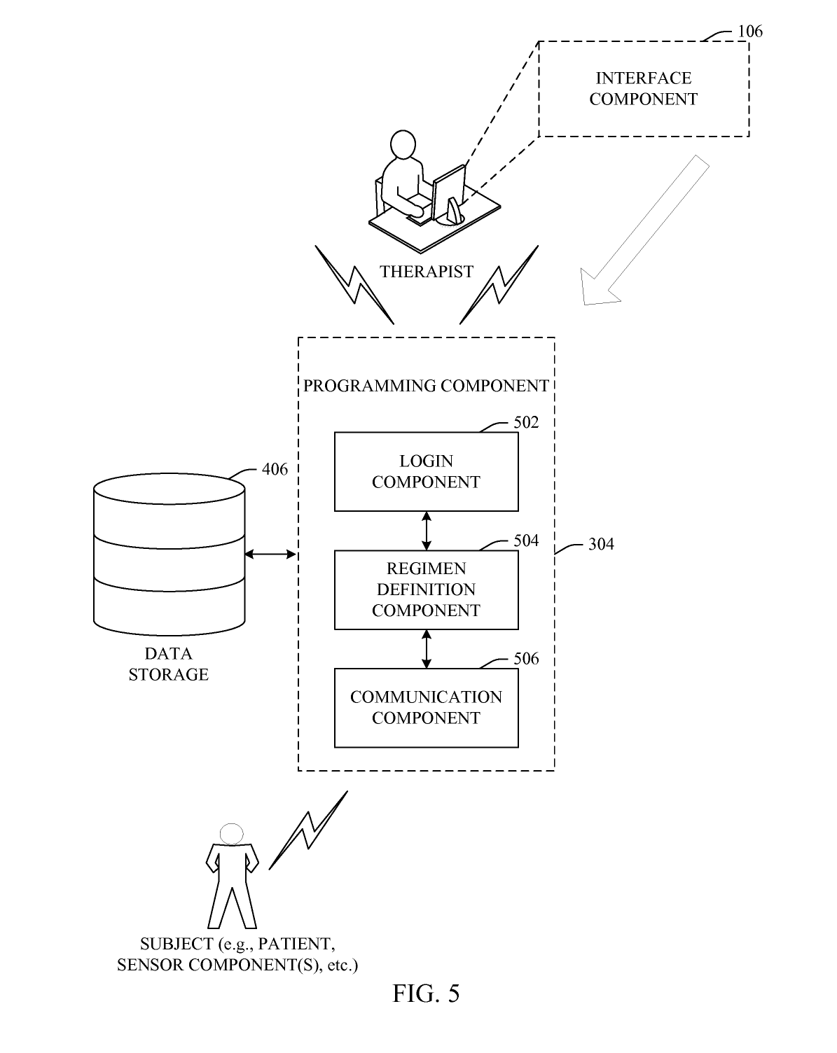

Referring now to FIG. 5, an example programming component 304 is shown. As illustrated, the programming component 304 can include a login component 502, a regimen definition component 504 and a communication component 506 in aspects. The login component 502 provides for secure login to the system. For instance, the login component 502 can require specific credentials so as to login for access to patient data, regimen definition, etc. The regimen definition component 504 enables a user to program or otherwise alter a regimen. The communication component 506 provides functionality so as to enable communication between a subject and therapist or the like. In accordance with the innovation, the communication can be via email, SMS/text message, video call, or the like.

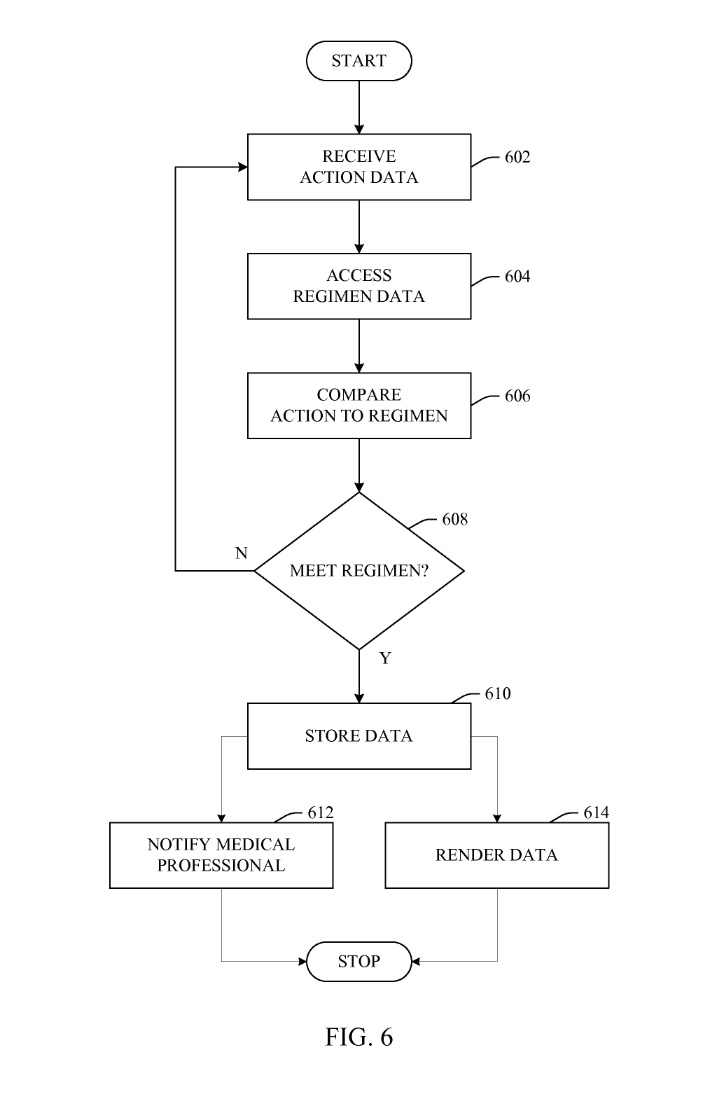

FIG. 6 illustrates a methodology of monitoring motion in accordance with an aspect of the innovation. While, for purposes of simplicity of explanation, the one or more methodologies shown herein, e.g., in the form of a flow chart, are shown and described as a series of acts, it is to be understood and appreciated that the subject innovation is not limited by the order of acts, as some acts may, in accordance with the innovation, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation.

At act 602, action data can be received, for example, via sensor components strategically placed to monitor a desired a desired location (e.g., joint). Regimen data can be accessed and retrieved at 604 for comparison at 606. Here, the actual motion/action data can be compared to a desired regimen at most any level of granularity. In other words, for example, a number of repetitions can be recorded, specific angles, locations and ranges of motion can be measured, calculated and compared to a desired regimen.

A decision is made at 608 to determine if a regimen was met satisfactorily. If not met, the methodology can return to 602 to continue to receive and capture action data. If the regimen is satisfactorily met, the data can be stored at 610 for example into a local, distributed, server-, cloud-based server, etc. As mentioned above, it is to be understood that the act of storing data can occur at most any time (or not at all) within the methodology in other aspects.

Medical personnel can be notified at 612. Here, the notification can be sent via most any suitable means including, but not limited to, SMS, MMS, email, etc. The notification can alert a medical professional that data is available for review. In other aspects, filters can be provided and used that alert in specific (or random) instances. For example, a medical professional or therapist may only be interested in being alerted when a regimen is not met. Thus, the system provides for filtering so as to provide meaningful and desired alerts.

As described supra, exercise data can be rendered at 614 in most any desired format. In examples, statistical data (e.g., ROM, date, time, number of repetitions, etc.) can be provided. Other embodiments can include graphs, videos, etc. These and other aspects will be understood and appreciated in view of this specification. The variations are to be included within the spirit and scope of the innovation and claims appended hereto.

Following is a description of a specific example of the innovation in order to provide context and perspective to the features, functions and benefits of the innovation. This example will aid in an understanding of the innovation and is not intended to limit its scope in any manner.

In this example, the system is used to measure subject cervical range of motion. The system can include two Inertial Motion Units (IMUs) (e.g., sensors 202, 204 of FIG. 2) and a data logger (e.g., 206 of FIG. 2). As shown in FIG. 2, one IMU can be placed on the patient's head, while the second can be placed between the shoulder blades, and the data logger can be clipped on the patient's hip belt. Other aspects can employ the processing and storage functionality of a smartphone, tablet, etc., for example, in place of a standalone data logger.

The IMU placed on the head would ideally be placed behind the ear similar to a hearing aid, or a wireless Bluetooth™ phone headset to ensure patient's comfort and concealment of the device while worn. In the aspect, the IMU placed between the shoulder blades can be mounted using a double sided medical adhesive tape which will be taped on the patient's back. Finally, the data logger placed on the hip can employ a storage medium (e.g., microSD card, internal storage, flash, etc.) to store the data. In the case of a microSD card or the like, the medium can be removed and connected to the computer to download the data. As described above, in other aspects, the data transmission between the sensors, data logger and/or external computer can be accomplished in a wired or wireless manner (e.g., Bluetooth™, RFID, etc.).

The aspect shown in FIG. 2 attaches the sensors (IMUs) to the data logger using a wired connection. The wires will be used to transmit data and power, thus the data logger can host the battery which can power both IMUs and the logger. In another aspect, the system can employ wireless (e.g., Bluetooth™) modules to the sensors thus the wires can be eliminated. In addition to the modules, each sensor can host its own battery. Data can be transmitted from the sensors to the data logger which can include or employ a Bluetooth™ receiver, a smart phone which has Bluetooth™ capabilities, or the like.

In a particular embodiment, the sensors can be VN-100™ Rugged as manufactured by VectoNAV, of Richardson, Tex. The VN-100™ is a miniature surface mount high performance Inertial Measurement Unit (IMU) and Attitude Heading Reference System (AHRS). Incorporating the latest solid-state MEMS (micro electro-mechanical system) sensor technology, the VN-100™ combines 3-axis accelerometers, 3-axis gyros, and 3-axis magnetic sensors as well as a 32-bit processor into a miniature surface mount module. Along with providing calibrated sensor measurements the VN-100™ also computes and outputs a real-time drift free 3-dimensional (3D) orientation solution that is continuous over the complete 360 degrees of motion.

The VN-100™ is available in two different configurations, as a surface mounted sensor (VN-100 SMT™), or as an enclosed sensor (VN-100 Rugged™). While either type of sensor can be employed in aspects, the VN-100 Rugged™ provides a robust precision anodized aluminum clamshell enclosure, ensuring precise alignment and calibration, while still retaining the smallest possible footprint.

The VN-100™ can be used as either an Inertial Measurement Unit (IMU) or as an orientation sensor (AHRS). As an IMU the VN-100™ relies on its high quality factory calibration. In order to ensure accuracy and reliability, every VN-100™ can be separately calibrated at the production facility to digitally remove errors in 10 onboard sensors caused by scale factor, bias and misalignment. This process typically provides a 5× to 10× improvement in overall accuracy compared to the original un-calibrated sensors. This digital alignment also ensures that each of the three 3-axis inertial sensors share the same coordinate frame, which is important for navigation applications.

For applications which require a full orientation solution, the VN-100™ offers an onboard Aerospace grade attitude estimation Kalman filter. This algorithm known as the Vector Processing Engine (VPE) provides a drift-free 3D-orientation solution that works in most any orientation and is capable of handling both acceleration and magnetic disturbances. While the VN-100™ is described in connection with this aspect, it is to be understood and appreciated that most any suitable sensor (including custom sensors) can be employed in alternative aspects. These variations are to be included within the scope of the innovation described herein.

Continuing with the example, the portable data logger (and battery pack) can be a device such as a Logomatic V2™ data logger manufactured by SparkFun, Inc. While other data logging devices (including smart phones) can be employed, the Logomatic employs a microSD card holder, a mini USB connection and a rechargeable Lithium battery connection. The battery can be recharged when the logger is connected to the computer via USB. Also, data can be downloaded from the microSD card when the unit is connected to the computer. There are 2 serial input channels and 8 Digital/Analog inputs in addition to LED (light emitting diode) indicators, stop and reset button and ON/OFF switch. The example logger can have several modes to store the data which can easily be controlled by adjusting the text file that is generated once the microSD card is formatted. This file is essential in ensuring which channels are open/closed, baud rates, type of data, etc.

The batteries used in this example are slim, light weight batteries based on the Polymer Lithium Ion chemistry. It will be appreciated that these battery types provide the highest energy density currently in production. Each cell can output a nominal 3.7V at 2000 mAh. This battery comes terminated with a standard 2-pin JST-PH connector—2 mm spacing between pins.

In the example, a micro-SATA (serial advanced technology attachment) hard drive enclosure from StarTech™ was selected for the prototype enclosure for the portable battery logger and battery pack. This item was chosen for its light-weight (2.2 ounces), durable aluminum construction and size: 8.3×2×5.3 inches, which is compatible with many popular cell/smart phone dimensions enabling off the shelf products to be used for user integration (arm bands, belt clips, etc.).

Turning now to a discussion of device validation, the maximal range of motion (ROM) of cervical decompression and fusion patients is reduced by approximately 20% compared to healthy individuals. This outcome measure can be used as an assessment of surgical success; however it is still unknown if this loss of motion significantly affects the patient's quality of life and ability to perform activities of daily living. Traditional magnetic motion tracking methods are limited to a controlled laboratory environment which does not simulate cervical motions performed during daily activities or exercise as can be performed by the subject innovation. Therefore, one objective of this innovation's development was to develop and validate a portable 6 degrees of freedom motion tracking device that accurately and precisely records cervical ROM.

The development and validation of the portable ROM device was tested against a 6-DOF robotic arm (e.g., Staubli RX-90). The device included two 6 degree of freedom motion sensors and a data logger. The ROM was calculated as the difference between these sensors. Moreover, the continuous measurement of the motion was stored on a data logger attached to the sensors by wires. As described supra, the logger can also contain a battery power supply and a microSD memory card to store the data. The microSD card can be connected (e.g., wired or wirelessly) to a computer (e.g., laptop, desktop, tablet, smart phone, etc.) to download the measured ROM. To calculate accuracy and precision of the device, data downloaded from the data logger can be compared against data recorded by the robot.

It will be understood by those skilled in the art that this innovation can enhance traditionally lab-only techniques to continuously measure the motion of cervical spine patients outside the laboratory, as well as other joint injury/rehabilitation. Contrary to conventional techniques, the innovation can record new parameters such as head motion trajectory and magnitude and frequency of cervical spine movements. These parameters open new doors towards analyzing the ROM of cervical patients and assist physicians and patients to better understand the effects of cervical spine surgery on patient's quality of life and daily range of motion. Moreover, this device can be used to monitor the patient's progress during rehabilitation sessions to recover, e.g., their cervical ROM.

As described in detail herein, the innovation can include an activity manager or interface component. This activity manager can be used for data uploaded and can be used by the therapist and the patient. In embodiments, the therapist can continuously monitor the patient's joint activity level, can remotely provide feedback and modify the patient's therapy protocol. Meanwhile, the patient will have access to the activity manager where he/she, in addition to viewing the progress of his/her joint activity, can review and learn the exercises prescribed by the therapist. In accordance therewith, the patient will gain confidence that his/her joint's activity is continuously supervised and monitored by the therapist to ensure recovery of his/her joint.

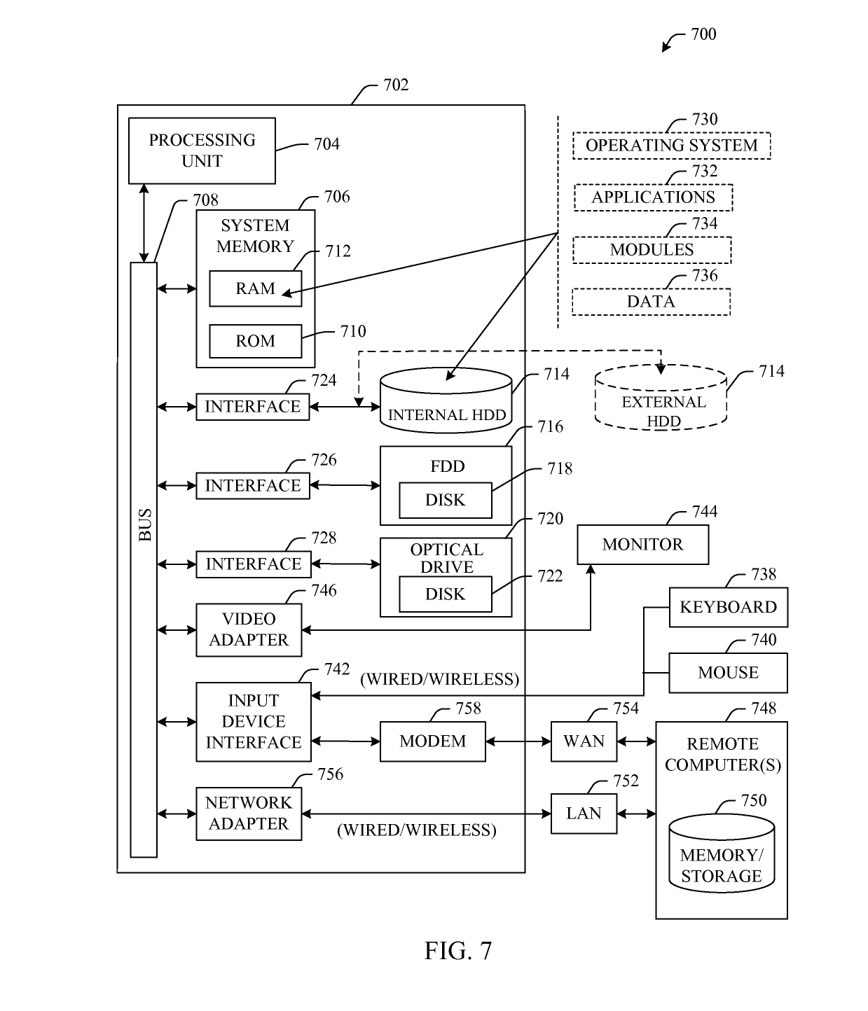

Referring now to FIG. 7, there is illustrated a block diagram of a computer operable to execute the disclosed architecture. In order to provide additional context for various aspects of the subject innovation, FIG. 7 and the following discussion are intended to provide a brief, general description of a suitable computing environment 700 in which the various aspects of the innovation can be implemented. While the innovation has been described above in the general context of computer-executable instructions that may run on one or more computers, those skilled in the art will recognize that the innovation also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the innovation may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 7, the exemplary environment 700 for implementing various aspects of the innovation includes a computer 702, the computer 702 including a processing unit 704, a system memory 706 and a system bus 708. The system bus 708 couples system components including, but not limited to, the system memory 706 to the processing unit 704. The processing unit 704 can be any of various commercially available processors. Dual microprocessors and other multi-processor architectures may also be employed as the processing unit 704.

The system bus 708 can be any of several types of bus structure that may further interconnect to a memory bus (with or without a memory controller), a peripheral bus, and a local bus using any of a variety of commercially available bus architectures. The system memory 706 includes read-only memory (ROM) 710 and random access memory (RAM) 712. A basic input/output system (BIOS) is stored in a non-volatile memory 710 such as ROM, EPROM, EEPROM, which BIOS contains the basic routines that help to transfer information between elements within the computer 702, such as during start-up. The RAM 712 can also include a high-speed RAM such as static RAM for caching data.

The computer 702 further includes an internal hard disk drive (HDD) 714 (e.g., EIDE, SATA), which internal hard disk drive 714 may also be configured for external use in a suitable chassis (not shown), a magnetic floppy disk drive (FDD) 716, (e.g., to read from or write to a removable diskette 718) and an optical disk drive 720, (e.g., reading a CD-ROM disk 722 or, to read from or write to other high capacity optical media such as the DVD). The hard disk drive 714, magnetic disk drive 716 and optical disk drive 720 can be connected to the system bus 708 by a hard disk drive interface 724, a magnetic disk drive interface 726 and an optical drive interface 728, respectively. The interface 724 for external drive implementations includes at least one or both of Universal Serial Bus (USB) and IEEE 1394 interface technologies. Other external drive connection technologies are within contemplation of the subject innovation.

The drives and their associated computer-readable media provide nonvolatile storage of data, data structures, computer-executable instructions, and so forth. For the computer 702, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the innovation.

A number of program modules can be stored in the drives and RAM 712, including an operating system 730, one or more application programs 732, other program modules 734 and program data 736. All or portions of the operating system, applications, modules, and/or data can also be cached in the RAM 712. It is appreciated that the innovation can be implemented with various commercially available operating systems or combinations of operating systems.

A user can enter commands and information into the computer 702 through one or more wired/wireless input devices, e.g., a keyboard 738 and a pointing device, such as a mouse 740. Other input devices (not shown) may include a microphone, an IR remote control, a joystick, a game pad, a stylus pen, touch screen, or the like. These and other input devices are often connected to the processing unit 704 through an input device interface 742 that is coupled to the system bus 708, but can be connected by other interfaces, such as a parallel port, an IEEE 1394 serial port, a game port, a USB port, an IR interface, etc.

A monitor 744 or other type of display device is also connected to the system bus 708 via an interface, such as a video adapter 746. In addition to the monitor 744, a computer typically includes other peripheral output devices (not shown), such as speakers, printers, etc.

The computer 702 may operate in a networked environment using logical connections via wired and/or wireless communications to one or more remote computers, such as a remote computer(s) 748. The remote computer(s) 748 can be a workstation, a server computer, a router, a personal computer, portable computer, microprocessor-based entertainment appliance, a peer device or other common network node, and typically includes many or all of the elements described relative to the computer 702, although, for purposes of brevity, only a memory/storage device 750 is illustrated. The logical connections depicted include wired/wireless connectivity to a local area network (LAN) 752 and/or larger networks, e.g., a wide area network (WAN) 754. Such LAN and WAN networking environments are commonplace in offices and companies, and facilitate enterprise-wide computer networks, such as intranets, all of which may connect to a global communications network, e.g., the Internet.

When used in a LAN networking environment, the computer 702 is connected to the local network 752 through a wired and/or wireless communication network interface or adapter 756. The adapter 756 may facilitate wired or wireless communication to the LAN 752, which may also include a wireless access point disposed thereon for communicating with the wireless adapter 756.

When used in a WAN networking environment, the computer 702 can include a modem 758, or is connected to a communications server on the WAN 754, or has other means for establishing communications over the WAN 754, such as by way of the Internet. The modem 758, which can be internal or external and a wired or wireless device, is connected to the system bus 708 via the serial port interface 742. In a networked environment, program modules depicted relative to the computer 702, or portions thereof, can be stored in the remote memory/storage device 750. It will be appreciated that the network connections shown are exemplary and other means of establishing a communications link between the computers can be used.

The computer 702 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11(a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

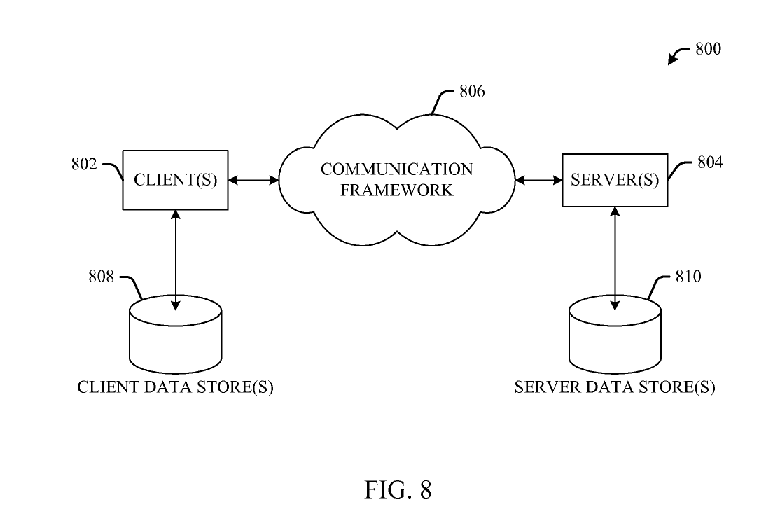

Referring now to FIG. 8, there is illustrated a schematic block diagram of an exemplary computing environment 800 in accordance with the subject innovation. The system 800 includes one or more client(s) 802. The client(s) 802 can be hardware and/or software (e.g., threads, processes, computing devices). The client(s) 802 can house cookie(s) and/or associated contextual information by employing the innovation, for example.

The system 800 also includes one or more server(s) 804. The server(s) 804 can also be hardware and/or software (e.g., threads, processes, computing devices). The servers 804 can house threads to perform transformations by employing the innovation, for example. One possible communication between a client 802 and a server 804 can be in the form of a data packet adapted to be transmitted between two or more computer processes. The data packet may include a cookie and/or associated contextual information, for example. The system 800 includes a communication framework 806 (e.g., a global communication network such as the Internet) that can be employed to facilitate communications between the client(s) 802 and the server(s) 804.

Communications can be facilitated via a wired (including optical fiber) and/or wireless technology. The client(s) 802 are operatively connected to one or more client data store(s) 808 that can be employed to store information local to the client(s) 802 (e.g., cookie(s) and/or associated contextual information). Similarly, the server(s) 804 are operatively connected to one or more server data store(s) 810 that can be employed to store information local to the servers 804.

What has been described above includes examples of the innovation. It is, of course, not possible to describe every conceivable combination of components or methodologies for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system that facilitates joint monitoring, comprising:
a plurality of sensors that capture data that represents dynamic and continuous activity of a joint; and
an action management system that processes at least a subset of the data as a function of a prescribed regimen.

2. The system of claim 1, wherein the joint is at least one of an elbow, shoulder, knee, low back, hip, or neck.

3. The system of claim 1, further comprising a monitoring component that receives the subset the data for processing or remote retrieval from a location accessible by a patient or a medical professional.

4. The system of claim 3, wherein the location is a website that enables communication of exercise instructions, placed by the medical professional or notifications to the patient regarding a therapy regimen.

5. The system of claim 1, further comprising an interface component that facilitates network access the subset of the data by a patient or a medical professional.

6. The system of claim 1, further comprising an analysis component that compares the subset of the data to the prescribed therapy regimen.

7. The system of claim 1, further comprising an analysis component that tags the subset of the data as a function of time, date, patient identification, and range of motion specifics.

8. The system of claim 1, further comprising a programming component that enables definition or alteration of the prescribed regimen.

9. The system of claim 1, further comprising a notification component that facilitates generation and transmission of a notification sent to either a patient or medical professional.

10. The system of claim 1, wherein the notification is one of an SMS, MMS, video or electronic mail communication.

11. The system of claim 1, further comprising a rendering component that provides the subset of the data via textual display, graph or video format.

12. The system of claim 1, wherein the plurality of sensors continuously measure the motion in 6-DOF (degrees of freedom).

13. The system of claim 1, further comprising a storage component that maintains the data.

14. The system of claim 5, wherein the storage component is one of a micro SD card, memory card, flash, local, distributed or cloud-based storage.

15. The system of claim 1 wherein the plurality of sensors includes at least two sensors placed across the joint and, further comprising a data logger that logs the data into a local or remote location.

16. The system of claim 1, wherein the plurality of sensors includes a 3-axis accelerometer, 3 axis gyroscope and a 3-axis magnometer that enable measurements in 6-DOF.

17. A computer-implemented method of tracking action data, comprising:
employing a processor that executes computer executable instructions stored on a computer readable storage medium to implement the following acts:
receiving action data from a plurality of sensors strategically places about a joint on a human body; and
storing a subset of the action data in a location accessible by a patient or medical professional.

18. The method of claim 17, further comprising accessing regimen data, comparing the subset of the action data to the regimen data and determining compliance with the regimen data.

19. The method of claim 18, further comprising generating and transmitting a notification, wherein the notification is one of an SMS, MMS, video or electronic mail message to one of the patient or medical professional to convey information concerning the subset of the action data.

20. A computer-executable system comprising:
computer-implemented means for tracking action data based upon motion of a joint on a human body;
computer-implemented means for logging a subset of the action data;
computer-implemented means for comparing the subset of the action data to a defined therapy regimen;
computer-implemented means for notifying one of a patient or medical professional based upon the defined therapy regimen; and
computer-implemented means for providing remote access to the action data.
